(19) United States
(12) Patent Application Publication
(10) Pub. No.: US 2017/0068127 A1
(43) Pub. Date: Mar. 9, 2017

(54) OPTICAL FILTER AND PHOTOLUMINESCENCE DISPLAY EMPLOYING THE SAME

(71) Applicant: Samsung Display Co., Ltd., Yongin-si (KR)

(72) Inventors: Junhan LEE, Yongin-si (KR); Donguk KIM, Yongin-si (KR); Youngmin KIM, Yongin-si (KR); Kisoo PARK, Yongin-si (KR); Haeil PARK, Yongin-si (KR)

(21) Appl. No.: 15/063,955

(22) Filed: Mar. 8, 2016

(30) Foreign Application Priority Data
Sep. 4, 2015 (KR) 10-2015-0125607

(51) Int. Cl. G02F 1/1335

(52) U.S. Cl. CPC G02F 1/133512; G02F 1/133621; G02F 2001/133614; G02F 2203/05; G02F 2203/055

(57) ABSTRACT

An optical filter configured to block light of a wavelength band less than a reference wavelength, in which a k index value of the optical filter is equal to or greater than 0.1 when a wavelength band is less than a reference wavelength, and less than or equal to 0.015 when a wavelength band is greater than the reference wavelength.

### CROSS-REFERENCE TO RELATED APPLICATION

This application claims priority from and the benefit of Korean Patent Application No. 10-2015-0125607, filed on Sep. 4, 2015, which is hereby incorporated by reference for all purposes as if fully set forth herein.

### BACKGROUND

Field

Exemplary embodiments relate to an optical filter and a photoluminescence display employing the optical filter.

Discussion of the Background

A flat panel display is applied to various electronic devices such as a computer monitor, a television, a cellular phone, a smart phone, a wearable device, a mobile terminal, etc. Examples of the flat panel display may include a liquid crystal display, an organic light-emitting display, etc.

A liquid crystal display may not include a self-emissive element, and thus may include a separate light source. In general, a liquid crystal display irradiates light to a liquid crystal panel by using a backlight unit disposed on a backside of the liquid crystal panel. When a liquid crystal display uses a color filter including, for example, red R, green G, and blue B filter elements, to display a color image, only light of a specific wavelength may pass through the filter elements of each of the colors constituting the color filter, in a region corresponding to each pixel. Thus, the liquid crystal display may utilize about ⅓ of white light provided by the backlight unit, thereby incurring a light loss.

A photoluminescence display is an image displaying apparatus that may utilize visible light generated by irradiating light of a short wavelength onto a color conversion layer, and, thus, may reduce the amount of light loss, compared to a structure applying the color filter.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an optical filter configured to prevent a color mixture and improve color reproduction by blocking excitation light that passes through a color conversion layer, and a photoluminescence display employing the optical filter.

Additional aspects will be set forth in the detailed description which follows and, in part, will be apparent from the disclosure, or may be learned by practice of the inventive concept.

According to an exemplary embodiment of the present invention, an optical filter is configured to block light having a wavelength band less than a reference wavelength, in which a k index value of the optical filter is equal to or greater than 0.1 when a wavelength band is less than a reference wavelength, and less than or equal to 0.015 when a wavelength band is greater than the reference wavelength.

According to an exemplary embodiment of the present invention, a photoluminescence display includes a light source configured to emit blue light, a light modulator configured to modulate incident light for each pixel region, a color conversion layer configured to emit photoluminescence by using the blue light as excitation light, the color conversion layer including color conversion regions respectively corresponding to pixel regions of the light modulator, and an optical filter including a filter region and configured to block the blue light, the filter region being configured to have a k index value equal to or greater than 0.1 in a wavelength band less than a reference wavelength, and less than or equal to 0.015 in a wavelength band greater than the reference wavelength.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic diagram of an optical filter according to an exemplary embodiment of the present invention.

FIG. 2 is a plan view of the optical filter of FIG. 1.

FIG. 3 is a schematic diagram of a photoluminescence display according to an exemplary embodiment of the present invention.

FIG. 4 is a schematic diagram illustrating a color conversion process in the photoluminescence display of FIG. 3.

FIG. 5 is a schematic diagram illustrating an operation of blocking blue light incident onto a filter region of an optical filter in the photoluminescence display of FIG. 4.

FIG. 6 is a graph illustrating a k index with respect to a wavelength when the transmittance of blue lateral light of an optical filter is below 1%.

FIG. 7A is a graph illustrating a k index with respect to a wavelength when the transmittance of blue lateral light of an optical filter is below 1%.

FIG. 7B is a graph of transmittance and chrominance of an optical filter having the k index of FIG. 7A.

FIGS. 8A and 8B show a stack structure and a reflectivity characteristic of a conventional blue light blocking optical filter according to a comparative embodiment.

FIG. 9 is a graph of a band shift for each incident angle of a conventional optical filter according to a comparative embodiment.

FIG. 10 is a diagram of comparison in a color coordinate characteristic between an optical filter according to an exemplary embodiment of the present invention and an optical filter according to a comparative embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

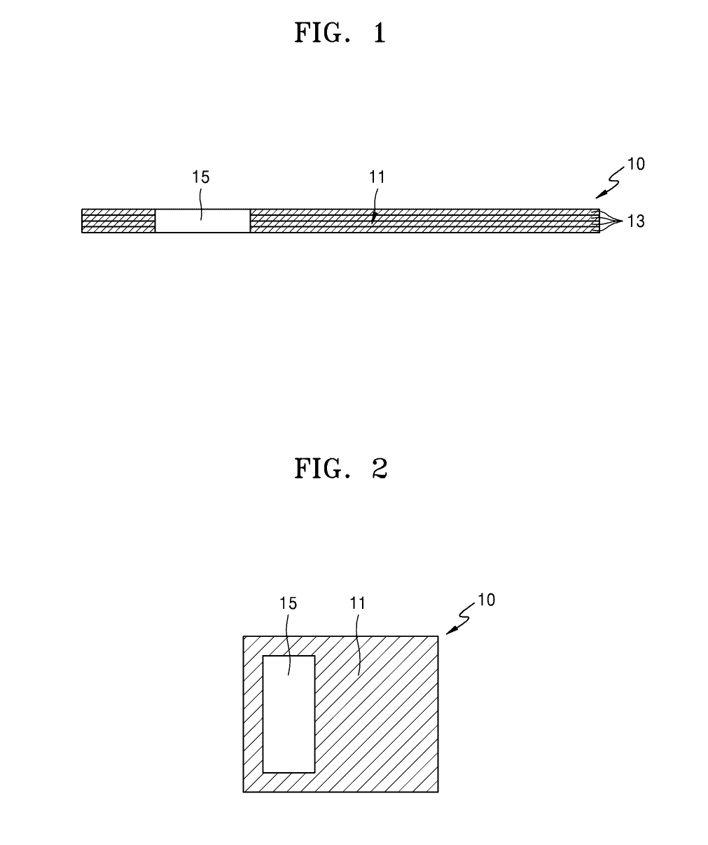

FIG. 1 is a schematic diagram of an optical filter 10 according an exemplary embodiment of the present invention. FIG. 2 is a plan view of the optical filter 10 of FIG. 1.

Referring to FIGS. 1 and 2, the optical filter 10 according to the present exemplary embodiment may include stacked layers 13 and a filter region 11 that may block light having a wavelength band less than a reference wavelength. The optical filter 10 may include one or more transparent windows 15 through which incident light passes.

The number of transparent windows 15, sizes thereof, shapes thereof, and layout thereof may be varied depending on a structure of a device to which the optical filter 10 is applied. For example, in a photoluminescence display, when a display utilizes a light source that emits blue light and the optical filter 10 is used to block the blue light, the transparent window 15 may be disposed at a location corresponding to a blue pixel. That is, a region of the optical filter 10 corresponding to a red pixel and a green pixel may be formed as the filter region 11, and a region of the optical filter 10 corresponding to the blue pixel may include the transparent window 15.

According to an exemplary embodiment of the present invention, the optical filter 10 may not include the transparent window 15. For example, when a photoluminescence display utilizes a light source that emits ultraviolet light and the optical filter 10 is used to block the ultraviolet light, the transparent window 15 may not be utilized, and, thus, a whole surface of the optical filter 10 may be formed as the filter region 11 for blocking the ultraviolet light.

The filter region 11 of the optical filter 10 may be configured to have a k index value equal to or greater than 0.1 with respect to a wavelength band less than a reference wavelength, and less than or equal to 0.015 with respect to a wavelength band greater than the reference wavelength. In this manner, the filter region 11 may block light of the wavelength band less than the reference wavelength incident thereto. In addition, the filter region 11 may also block light of the wavelength band less than the reference wavelength incident thereto with an incident angle. Hereinafter, light incident to the filter region 11 with an incident angle may be referred to as lateral light.

The reference wavelength may be varied according to a wavelength band to be blocked. For example, in a photoluminescence display that uses blue light as the excitation light, when the optical filter 10 is used to block excitation light, which is not converted by a color conversion layer, the wavelength band less than the reference wavelength may include a blue wavelength band and the reference wavelength may be, for example, about 490 nm. In this case, the optical filter 10 may include a multilayer thin film blue blocking filter, which may have a k index value equal to or greater than 0.1 in a wavelength band less than the blue wavelength, and a k index value less than or equal to 0.015 in a wavelength band greater than the blue wavelength. The wavelength band greater than the reference wavelength may include, for example, a green wavelength band. That is, the wavelength band greater than the reference wavelength may be, for example, about 500 nm or higher.

As described above, the optical filter 10 according to the present exemplary embodiment may include stacked layers 13, and a portion of the stacked layers 13 may have a k index value that is equal to or greater than 0.1 in the wavelength band less than the reference wavelength, and less than or equal to 0.015 in the wavelength band greater than the reference wavelength. One or more transparent windows 15, through which the wavelength band less than the reference wavelength passes, may be disposed in a first region of the optical filter 10. The transmittance of the optical filter 10 may be below 1% with respect to blue lateral light, which may be incident to the optical filter 10 at an incident angle of, for example, 60 degrees. Thus, a photoluminescence display including the optical filter 10 may prevent a color mixture and improve color reproduction.

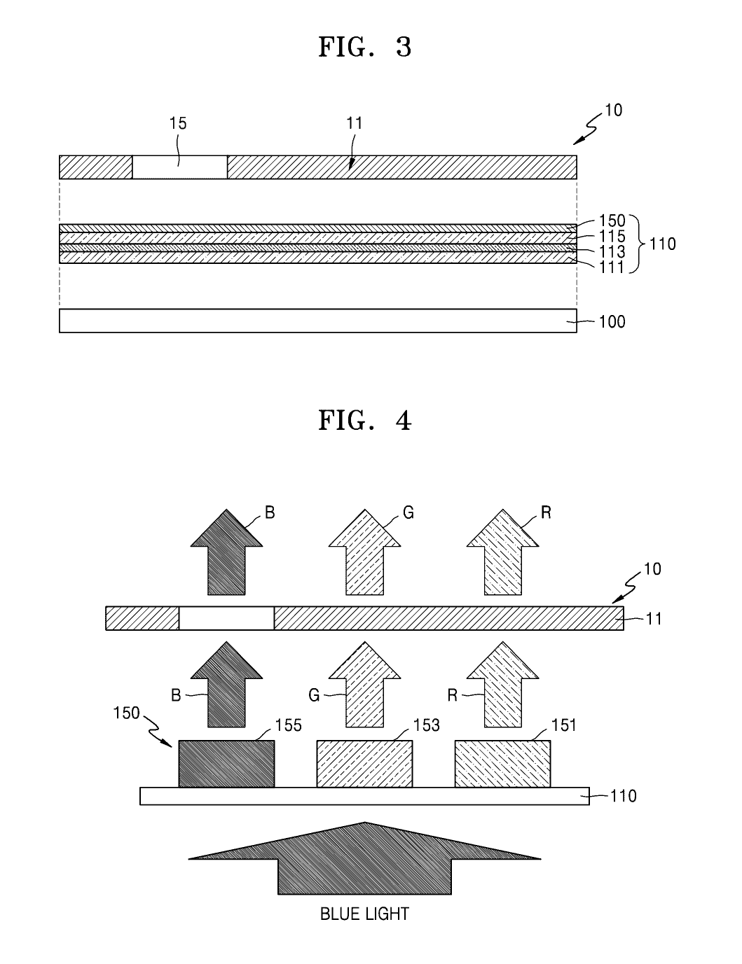

FIG. 3 is a schematic diagram of a photoluminescence display according an exemplary embodiment of the present invention. In order to avoid obscuring exemplary embodiments described herein, blue light emitting light source will be described as a light source of a photoluminescence display.

Referring to FIG. 3, the photoluminescence display according to the present exemplary embodiment may include a light source 100 that emits blue light, a light modulator 110 that modulates incident light for each pixel region, a color conversion layer 150, and the optical filter 10 including the filter region 11 that blocks the blue light. The color conversion layer 150 may emit photoluminescence by using the blue light as excitation light. The color conversion layer 150 may include color conversion regions respectively corresponding to the pixel regions of the light modulator 110.

The light source 100 may be configured to irradiate the blue light onto the light modulator 110. The light source 100 may include a backlight unit (not shown) of various structures used in a flat panel display. The light source 100 may include one or more light-emitting devices, such as a light-emitting diode or a laser diode that emits blue light. The light source 100 may further include a light guiding plate (not shown) that guides the blue light emitted from a light-emitting device towards the light modulator 110.

The light modulator 110 may be configured to modulate incident light for each of the pixel regions. The light modulator 110 may include, for example, first and second substrates 111 and 115 and a light modulation layer 113 disposed between the first and second substrates 111 and 115. For example, the light modulator 110 may be a liquid crystal light modulator, such as a liquid crystal panel.

When the light modulator 110 includes a liquid crystal light modulator, the light modulator 110 may include the first and second substrates 111 and 115 and a liquid crystal layer as the light modulation layer 113 disposed between the first and second substrates 111 and 115. The liquid crystal layer may convert polarization of incident light. More particularly, an arrangement of a liquid crystal layer may change according to an electric field formed by both ends of the liquid crystal layer, which may change the polarized state of light incident thereto. Accordingly, an amount of light that transmits through a polarization plate disposed on a front side of the light modulator 110 may be changed.

A switching device (not shown) such as a thin-film transistor, a pixel electrode (not shown), a gate line (not shown), a data line (not shown), etc., may be disposed on an inner surface of the first substrate 111. The thin-film transistor may be formed as an array to drive liquid crystal for each of the pixel regions. A common electrode (not shown), etc. may be disposed on an inner surface of the second substrate 115.

When the light source 100 includes a laser diode, etc. and irradiates specific polarization light onto the light modulator 110, a polarization plate (not shown) may be disposed only on the front side of the light modulator 110. When the light source 100 includes the light-emitting diode, etc. and irradiates non-polarization light onto the light modulator 110, polarization plates (not shown) may be disposed on the front side and back side of the light modulator 110. In this manner, although the case where the light modulator 110 includes a liquid crystal light modulator is described above as an example, the light modulator 110 may include a different type of a light modulator, which may modulate light for each of the pixel regions. Elements constituting the light modulator 110 are generally well known in the field of displays, and, thus, constituent elements of the light modulator 110 with respect to the first and second substrates 111 and 115 and the light modulation layer 113 will be described in more detail.

A color conversion layer 150 may be disposed on one side of the light modulator 110. The color conversion layer 150 may be disposed on one of the first and second substrates 111 and 115 of the light modulator 110. FIG. 3 shows an example in which the color conversion layer 150 is disposed on the second substrate 115. The color conversion layer 150 may be disposed on an inner surface of the second substrate 115. As another example, the color conversion layer 150 may be disposed on the first substrate 111.

Referring to FIG. 4, the color conversion layer 150 may include color conversion regions 151 and 153, respectively corresponding to the pixel regions of the light modulator 110. The color conversion regions 151 and 153 may be configured to emit photoluminescence by using blue light as excitation light. As used herein, photoluminescence may refer to a phenomenon that a material is stimulated by light and emits light, as a fluorescent phenomenon or phosphorescent phenomenon. Luminescence may refer to a phenomenon that a material absorbs energy, such as light, electricity, or radiation, and enters an excitation state and emits the absorbed energy as light, when the excitation state returns to a ground state. To generate luminescence based on light excitation, a wavelength range of the excitation light may correspond to a light absorption region of fluorescent material. Photoluminescence may generally emit light having the same wavelength as that of the excitation light or a wavelength longer than the wavelength of the excitation light, thereby generating light of a green wavelength band and a red wavelength band by using the blue light.

The color conversion layer 150 may include the red color conversion region 151 corresponding to a red pixel and the green color conversion region 153 corresponding to a green pixel. The red color conversion region 151 may emit red light R by using incident blue light as the excitation light. The green color conversion region 153 may emit green light G by using the incident blue light as the excitation light. A transparent region 155 through which incident blue light B passes or a blue color conversion region that emits the blue light B may be formed in a region corresponding to a blue pixel of the color conversion layer 150. In order to avoid obscuring exemplary embodiments described herein, the transparent region 155 being formed in a region corresponding to the blue pixel of the color conversion layer 150 will be further described below.

The red color conversion region 151 may include a red luminescence material including a red fluorescent substance that may convert the blue light B as the excitation light into the red light R. The green color conversion region 153 may include a green luminescence material including a green fluorescent substance that may convert the blue light B as the excitation light into the green light G.

The red fluorescent substance may include at least one of, for example, Y₂O₂S, La₂O₂S, (Ca, Sr, Ba)₂Si₅N₈, (CaAlSiN3), (La, Eu)₂W₃O₁₂, (Ca, Sr, Ba)₃MgSi₂O₈, and Li(Eu, Sm)W₂O₈. The green luminescence material may include at least one of, for example, (Ca, Sr, Ba)₂SiO₄, BAM, (α-SiAlON), Ca₃Sc₂Si₃O₁₂, Tb₃Al₅O₁₂, and LiTbW₂O₈.

Among the blue light incident onto the color conversion layer 150, the blue light B incident onto the transparent region 155 may pass through the transparent region 155 without a color conversion. Referring to FIG. 4, when the blue color conversion region is formed on a region corresponding to the transparent region 155, the blue light B may be generated in the blue color conversion region with respect to the incident blue light.

Among the blue light incident onto the color conversion layer 150, the blue light incident onto the red color conversion region 151 may be converted into the red light R by the red fluorescent substance. The blue light incident onto the green color conversion region 153 may be converted into the green light G by the green fluorescent substance.

As described above, a photoluminescence display may display colors of red, green, and blue by utilizing the color conversion layer 150, which is configured to generate red and green photoluminescence, by using the blue light irradiated from the light source 100 as the excitation light.

A portion of the blue light incident onto the color conversion layer 150 may pass through the color conversion layer 150 without being converted into the red light R and the green light G by the red color conversion region 151 and the green color conversion region 153, respectively. As such, the blue light may be partially mixed with the red light R and the green light G in the regions corresponding to the red and green pixels.

The optical filter 10 may include the filter region 11 to block the blue light at least in the regions corresponding to the red and green pixels. The filter region 11 may be formed to have a k index value, which may be equal to or greater than 0.1 with respect to a wavelength band less than a reference wavelength, and may be less than or equal to 0.015 with a wavelength band greater than the reference wavelength. The wavelength band less than the reference wavelength may include a blue wavelength band. For example, the reference wavelength may be about 490 nm. The wavelength band greater than the reference wavelength may include, for example, a green wavelength band. The wavelength band greater than the reference wavelength may be, for example, about 500 nm or greater.

The filter region 11 of the optical filter 10 may include the stacked layers 13. In this regard, at least a portion of the stacked layers 13 may be formed to have a k index value equal to or greater than 0.1 in the wavelength band less than the reference wavelength, and less than or equal to 0.015 in the wavelength band greater than the reference wavelength. For example, each of the stacked layers 13 may be formed to have a k index value equal to or greater than 0.1 in the wavelength band less than the reference wavelength, and less than or equal to 0.015 in the wavelength band greater than the reference wavelength.

When the optical filter 10 includes a stack of thin-film layers 13, if conditions such as a type of a material, a flow control thereof, deposition power, a processing pressure, etc. are adjusted during deposition of the thin-films 13, each of the thin-film layers 13 may be formed to have a k index value of a desired condition.

A region corresponding to the blue pixel of the optical filter 10 may include the transparent window 15 through which the incident blue light B may pass. The transparent window 15 of the optical filter 10 may correspond to the transparent region 155 or the blue color conversion region of the color conversion layer 150.

An overall region of the optical filter 10, excluding the transparent window 15, may include the filter region 11. FIGS. 3 and 4 show a portion of a photoluminescence display, in which only one transparent window 15 is disposed on the optical filter 10. It is noted that the photoluminescence display may include sets of the red, green, and blue pixels arranged in two dimensional arrays, and, thus, the transparent window 15 of the optical filter 10 may be formed in each region corresponding to blue pixels with respect to the entire display surface of the photoluminescence display.

As described above, the filter region 11 of the optical filter 10 may include a multilayer thin film blue blocking filter, which may have a k index value equal to or greater than 0.1 in a wavelength band less than the blue wavelength, and less than or equal to 0.015 in a wavelength band greater than the blue wavelength. In the filter region 11 of the optical filter 10 formed to satisfy the condition of the k index described above, the transmittance of blue lateral light incident to the filter region 11 at an incident angle of, for example, about 60 degrees may be below about 1% .

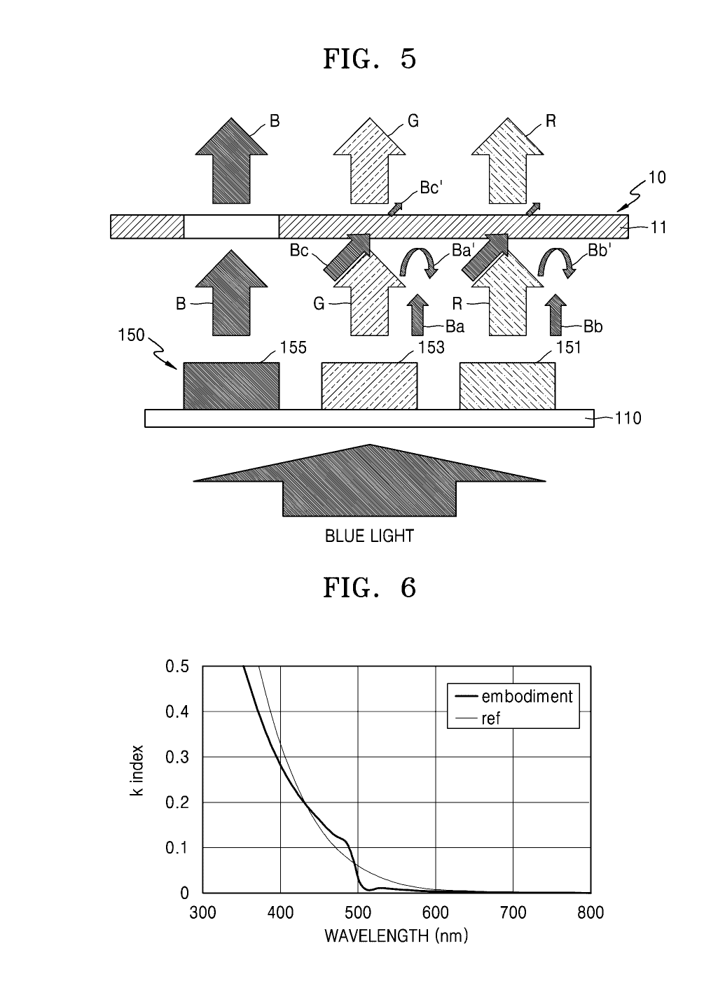

FIG. 5 is a schematic diagram illustrating an operation of blocking blue light incident onto the filter region 11 of the optical filter 10 in the photoluminescence display of FIG. 4.

Referring to FIG. 5, excitation light Ba that is not converted to green light G in the green color conversion region 153 and excitation light Bb that is not converted to red light R in the red color conversion region 151 may be reflected by, thus being blocked by, the filter region 11 of the optical filter 10, when the excitation lights Ba and Bb are incident onto a front of the filter region 11. Reflection light Ba′ may refer to the excitation light Ba reflected from the filter region 11 and reflection light Bb′ may refer to the excitation light Bb reflected from the filter region 11.

In the optical filter 10 according to the present exemplary embodiment, since the transmittance of the excitation lights Ba and Bb that are vertically incident onto the filter region 11 may be substantially zero, the excitation lights Ba and Bb may be mostly reflected from the filter region 11.

When blue lateral light Bc is emitted and incident onto the filter region 11, since the transmittance of the filter region 11 is below about 1% with respect to the blue lateral light Bc incident at an incident angle of, for example, about 60 degrees, the blue lateral light Bc may be mostly blocked by the filter region 11. A portion of blue lateral light Bc′ may pass through the filter region 11, which may be substantially small as compared to the green light G and the red light R that pass through the filter region 11.

FIG. 6 is a graph illustrating a k index with respect to a wavelength, when the optical filter 10 has the transmittance below 1% with respect to blue lateral light. Table 1 shows design data indicating the graph of FIG. 6. In FIG. 6 and Table 1, “ref” may refer to a characteristic of a k index value with respect to a wavelength of a conventional general optical filter that blocks blue light.

TABLE 1

| wavelength (nm) | k index of optical filter | k index of ref |
|---|---|---|
| 487.2 | 0.1043 | 0.0784 |
| 505.47 | 0.0141 | 0.0565 |
| 529.66 | 0.0107 | 0.0358 |
| 553.04 | 0.0082 | 0.0223 |
| 575.91 | 0.0062 | 0.0139 |
| 598.13 | 0.0047 | 0.0091 |
| 630.68 | 0.0031 | 0.0063 |

As shown in FIG. 6 and Table 1, when the filter region 11 of the optical filter 101 is formed to have a k index value that is equal to or greater than 0.1 with respect to a wavelength less than about 490 nm, and is less than or equal to 0.015 with a wavelength greater than about 500 nm, vertically incident blue light may be blocked and laterally incident blue light may be blocked at a transmittance below about 1%, without deteriorating the transmittance of the green light G or the red light R.

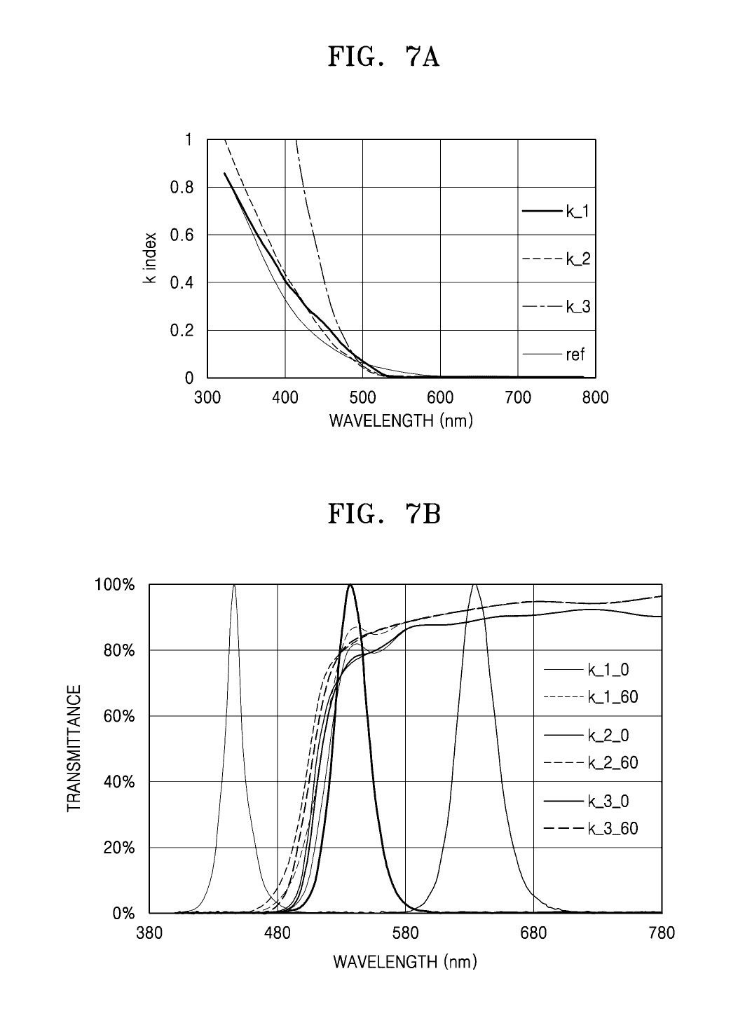

FIG. 7A is a graph illustrating a k index value with respect to a wavelength when the transmittance of blue lateral light of the optical filter 10 is designed to be below 1%. FIG. 7B is a graph illustrating transmittance and chrominance of the optical filter 10 having the k index of FIG. 7A. Table 2 shows design data indicating the graphs of FIGS. 7A and 7B. In FIG. 7A and Table 2, “ref” may refer to a characteristic of the k index with respect to a wavelength of a conventional optical filter that blocks blue light.

Referring to FIGS. 7A and 7B and Table 2, k_1, k_2, and k_3, respectively, indicate optical filters 10 according to exemplary embodiments of the present invention having transmittance of the blue light below about 1% in the front and lateral thereof. The graphs of k_1_0, k_2_0, and k_3_0 of FIG. 7B, respectively, show transmittance in the front of corresponding optical filter 10 of k_1, k_2, and k_3 of FIG. 7A. The graphs of k_1_60, k_2_60, and k_3_60 of FIG. 7B, respectively, show transmittance of the blue lateral light incident at about 60 degrees in the corresponding optical filter 10 of k_1, k_2, and k_3 of FIG. 7A.

TABLE 2

| wavelength (nm) | k_1 | k_2 | k_3 |
|---|---|---|---|
| 404 | 0.3900 | 0.4100 | 1.2000 |
| 428 | 0.3450 | 0.3450 | 0.9200 |
| 430 | 0.2900 | 0.2800 | 0.7000 |
| 450 | 0.2300 | 0.1900 | 0.4200 |
| 467 | 0.1600 | 0.1200 | 0.2200 |
| 490 | 0.1050 | 0.0780 | 0.1050 |
| 505 | 0.0560 | 0.0300 | 0.0380 |
| 530 | 0.0107 | 0.0107 | 0.0107 |
| 553 | 0.0082 | 0.0082 | 0.0082 |
| 576 | 0.0062 | 0.0062 | 0.0062 |
| 599 | 0.0047 | 0.0047 | 0.0047 |
| 630 | 0.0031 | 0.0031 | 0.0031 |
| 652 | 0.0023 | 0.0023 | 0.0023 |
| 682 | 0.0015 | 0.0015 | 0.0015 |

As shown in FIG. 7A and Table 2, when the filter region 11 of the optical filter 10 is formed to have a k index value that is equal to or greater than 0.075 with respect to a wavelength less than about 490 nm, for example, between about 490 nm and about 400 nm, and is less than or equal to 0.015 with a wavelength greater than about 510 nm, for example, between about 510 nm and about 680 nm, vertically incident blue light may be blocked and laterally incident blue light may be blocked at a transmittance below about 1%, without deteriorating the transmittance of the green light G or the red light R.

Referring to FIG. 7B and Tables 3 and 4, a change in transmittance of the blue light in the front and lateral of the optical filter 10 and a change in chrominance are substantially small between the exemplary embodiments of k_1, k_2, and k_3. Table 3 shows a change in the transmittance of the blue light in the front (e.g., k_1_0) and lateral (e.g., k_1_60) of the respective optical filter 10 for exemplary embodiments of k_1, k_2, and k_3, based on the transmittance characteristics of FIG. 7B. Table 4 shows a result of chrominance Δu′v′ calculated when the blue light is incident onto the front of the optical filter 10 and laterally incident onto the optical filter 10 at about 60 degrees according to the exemplary embodiments of k_1, k_2, and k_3, based on the transmittance characteristic of FIG. 7B.

TABLE 3
Blue Front/Lateral Transmittance Variation (%)

| k_1_0→ k_1_60 | | k_2_0→ k_2_60 | | k_3_0→ k_3_60 | |
|---|---|---|---|---|---|
| 0.1 | 0.3 | 0.1 | 0.7 | 0 | 0.1 |

TABLE 4

| condition | color | Δu‘v’ |
|---|---|---|
| k_1 | Green | 0.0017 |
| | Red | 0.0042 |
| k_2 | Green | 0.0022 |
| | Red | 0.0082 |
| k_3 | Green | 0.0014 |
| | Red | 0.0023 |

In general, chrominance Δu′v′ below about 0.004 may not be perceivable. According to table 4, the optical filter 10 according to the exemplary embodiments of k_1, l_2, and k_3 may almost satisfy the condition that the chrominance is below about 0.004, for the red light and the green light.

Therefore, when the filter region 11 of the optical filter 10 is formed such that a k index value is equal to greater than 0.75 with respect to a wavelength less than about 490 nm and is less than or equal to 0.015 with a wavelength greater than about 510 nm, the blue lateral light incident at an incident angle of about 60 degrees may be blocked at a transmittance below about 1%. In addition, a chrominance in the red light R and the green light G for each optical filter 10 according to exemplary embodiments may occur to a level that may not be perceivable.

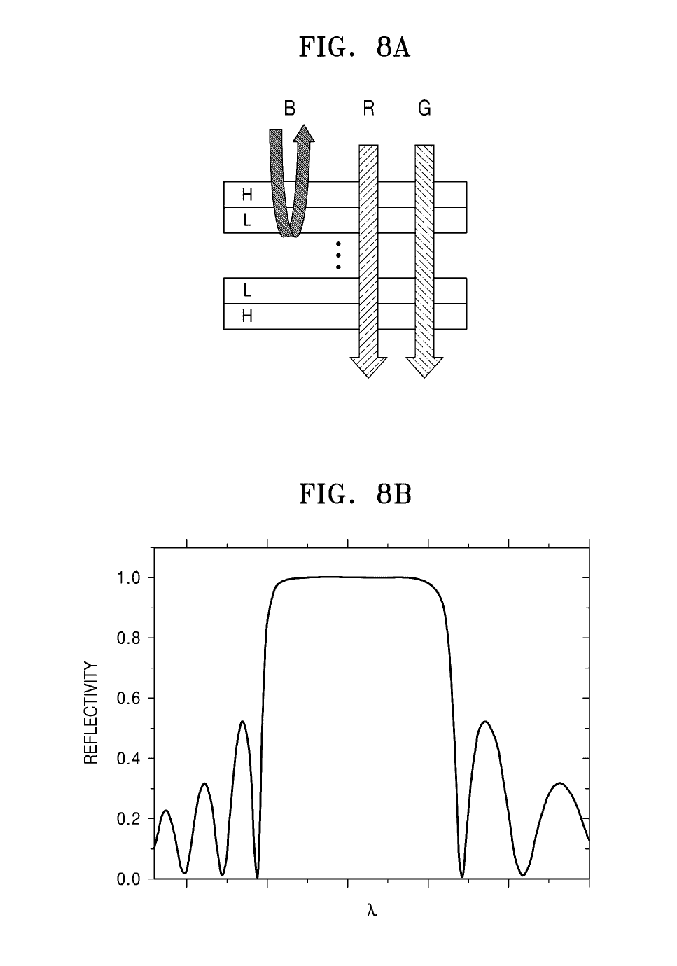

FIGS. 8A and 8B show a stack structure and a reflectivity characteristic of a conventional blue light blocking optical filter, according to a comparative embodiment.

Referring to FIG. 8A, the conventional blue light blocking optical filter may include alternately stacked high refractive index dielectric layers H and low refractive index dielectric layers L, and each layer is formed to have a thickness of λ/4. In this manner, reflective waves from the conventional blue light blocking optical filter may become a high reflective light, due to supplementary interference at boundary surfaces of the high refractive index dielectric layers H and the low refractive index dielectric layers L. When the number of stacked high refractive index dielectric layers H and low refractive index dielectric layers L is sufficient, as shown in FIG. 8B, an optical filter having a high reflectivity that is approximately close to 1 at a specific wavelength band may be formed. Thus, when a center wavelength is set to about 450 nm, blue light may be blocked.

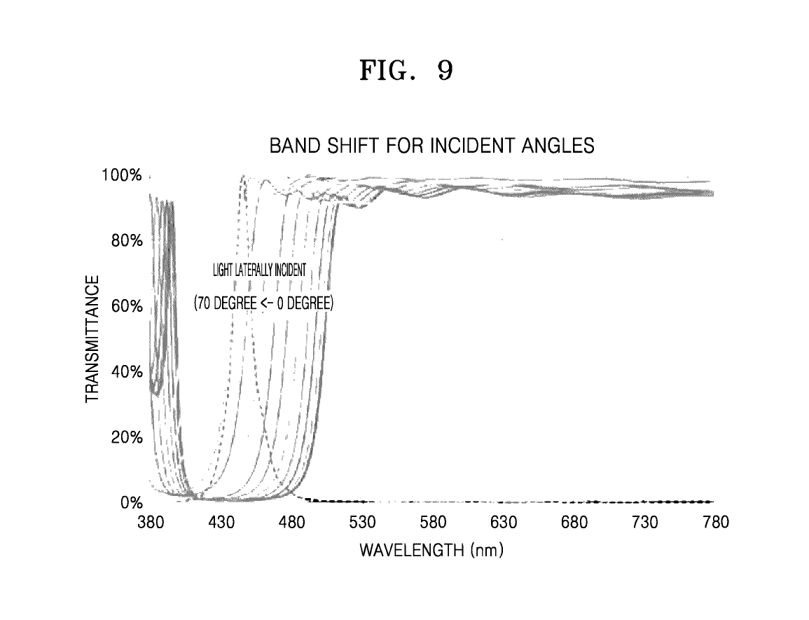

When the optical filter is designed to have a specific center wavelength, a reflectance characteristic may be satisfied with respect to vertically incident light. However, for laterally incident light, a center portion of a reflectance band may be shifted to a shorter wavelength as an incident angle increases, as shown in FIG. 9.

FIG. 9 is a graph of a band shift for each incident angle of a conventional optical filter according to a comparative embodiment.

According to the optical filter of the comparative embodiment, light of a wavelength that is reflected when the light is vertically incident may be transmitted when the light is laterally incident onto the optical filter. Accordingly, light blocking rate of a conventional optical filter may be deteriorated, thereby causing a color mixture.

In an optical filter 10 according to an exemplary embodiment of the present invention, the filter region 11 of the optical filter 10 may be formed such that a k index value is equal to or greater than 0. 1 with respect to a wavelength less than a reference wavelength, and is less than or equal to 0.015 with a wavelength greater than the reference wavelength. Thus laterally incident light may be blocked at a transmittance below about 1%, little chrominance may occur, and accordingly, the color mixture may be prevented.

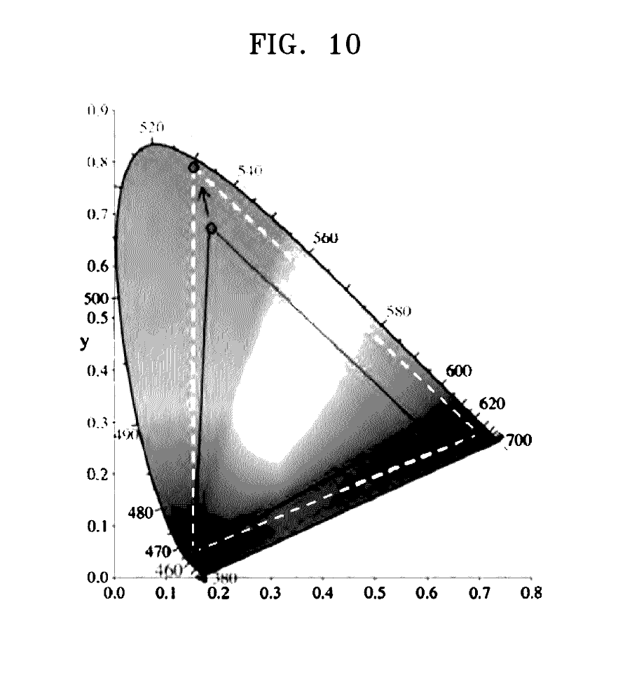

FIG. 10 is a diagram of comparison in a color coordinate characteristic between the optical filter 10 according to the present exemplary embodiment and the conventional optical filter according to a comparative embodiment. As shown in FIG. 10, according to the optical filter 10, blue lateral light may be blocked by red and green regions, little chrominance may occur, and, thus a color mixture may be prevented, thereby increasing color reproduction.

As described above, according to one or more exemplary embodiments of the present invention, an optical filter and a photoluminescence display employing the optical filter may prevent a color mixture and improve color reproduction, by blocking excitation light that passes through a color conversion layer.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. An optical filter configured to block light having a wavelength band less than a reference wavelength,
wherein a k index value of the optical filter is:
equal to or greater than 0.1, when a wavelength band less is less than the reference wavelength; and
less than or equal to 0.015, when a wavelength band is greater than the reference wavelength.

2. The optical filter of claim 1, wherein the wavelength band less than the reference wavelength comprises a blue wavelength band.

3. The optical filter of claim 1, wherein the reference wavelength is 490 nm.

4. The optical filter of claim 1, wherein the optical filter comprises a multilayer thin film blue blocking filter, the multilayer thin film blue blocking filter configured to have a k index value:
equal to or greater than 0.1, when a wavelength band is less than a blue wavelength; and
less than or equal to 0.015, when a wavelength band is greater than the blue wavelength.

5. The optical filter of claim 4, wherein the transmittance of blue lateral light incident to the multilayer thin film blue blocking filter at an incident angle of 60 degrees is below about 1%.

6. The optical filter of claim 1, wherein the wavelength band greater than the reference wavelength comprises a green wavelength band.

7. The optical filter of claim 6, wherein the wavelength band greater than the reference wavelength is 500 nm or greater.

8. The optical filter of claim 1, further comprising stacked layers,
wherein at least a portion of the stacked layers is configured to have a k index value equal to or greater than 0.1 in the wavelength band less than the reference wavelength, and less than or equal to 0.015 in the wavelength band greater than the reference wavelength.

9. The optical filter of claim 8, further comprising at least one transparent window through which the wavelength band less than the reference wavelength is configured to pass.

10. A photoluminescence display comprising:
a light source configured to emit blue light;
a light modulator configured to modulate incident light for each pixel region;
a color conversion layer configured to emit photoluminescence by using the blue light as excitation light, the color conversion layer comprising color conversion regions respectively corresponding to pixel regions of the light modulator; and
an optical filter comprising a filter region and configured to block the blue light, the filter region being configured to have a k index value equal to or greater than 0.1 in a wavelength band less than a reference wavelength, and less than or equal to 0.015 in a wavelength band greater than the reference wavelength.

11. The photoluminescence display of claim 10, wherein the light modulator comprises a liquid crystal light modulator.

12. The photoluminescence display of claim 11, wherein:
the light modulator comprises a first substrate, a second substrate, and
a liquid crystal layer disposed between the first and second substrates; and
the color conversion layer is disposed on one of the first and second substrates.

13. The photoluminescence display of claim 10, wherein the color conversion layer comprises:
a red color conversion region corresponding to a red pixel of the light modulator and configured to emit red light by using incident blue light as excitation light;
a green color conversion region corresponding to a green pixel of the light modulator and configured to emit green light by using the incident blue light as the excitation light; and
a transparent region corresponding to a blue pixel of the light modulator and through which the incident blue light passes.

14. The photoluminescence display of claim 13, wherein:
the optical filter comprises a transparent window corresponding to the transparent region of the color conversion layer, the transparent window being configured to pass the incident blue light.

15. The photoluminescence display of claim 10, wherein the wavelength band less than the reference wavelength comprises a blue wavelength band.

16. The photoluminescence display of claim 10, wherein the reference wavelength is about 490 nm.

17. The photoluminescence display of claim 10, wherein the filter region of the optical filter comprises a multilayer thin film blue blocking filter, the multilayer thin film blue blocking filter being configured to have a k index value equal to or greater than 0.1 in a wavelength band less than a blue wavelength, and less than or equal to 0.015 in a wavelength band greater than the blue wavelength.

18. The photoluminescence display of claim 17, wherein the transmittance of blue lateral light incident to the filter region at an incident angle of 60 degrees is below about 1%.

19. The photoluminescence display of claim 10, wherein the wavelength band greater than the reference wavelength is 500 nm or greater.

20. The photoluminescence display of claim 10, wherein the filter region comprises stacked layers,
wherein at least a portion of the stacked layers has a k index value equal to or greater than 0.1 in the wavelength band less than the reference wavelength, and less than or equal to 0.015 in the wavelength band greater than the reference wavelength.
